(19) United States
(12) Patent Application Publication
(10) Pub. No.: US 2025/0075729 A1
(43) Pub. Date: Mar. 6, 2025

(54) BOLT SYSTEM

(71) Applicant: Israel Aerospace Industries Ltd., Lod (IL)

(72) Inventors: Yaacov KRAIZMAN, Lod (IL); Tal LAHAV, Lod (IL); Dori ASSAF, Lod (IL)

(21) Appl. No.: 18/724,785

(22) PCT Filed: Dec. 28, 2022
(86) PCT No.: PCT/IL2022/051401

§ 371 Date: Jun. 27, 2024

(30) Foreign Application Priority Data
Dec. 30, 2021 (IL) 290029

(51) Int. Cl. F16B 31/00; B64G 1/64; F42B 3/00; F42C 15/34

(52) U.S. Cl. CPC F16B 31/005; F42B 3/006; F42C 15/34; B64G 1/6455

(57) ABSTRACT

An explosive bolt system includes an explosive bolt and an initiator device. The explosive bolt includes a shank having a first longitudinal end, an opposed second longitudinal end, and a longitudinal axis. The explosive bolt is configured for securing two elements together between the first longitudinal end and the second longitudinal end. The shank includes an internal chamber accommodating a first layer of a high density first secondary explosive material, and further accommodating a second layer of a low density second secondary explosive material in arming communication with the first layer. The initiator device is positioned with respect to the explosive bolt such that the initiator device is in arming communication with the explosive bolt.

### TECHNOLOGICAL FIELD

The presently disclosed subject matter relates to explosive bolts, in particular to explosive bolts that are used for separating two connected components.

### BACKGROUND

Explosive bolts are well known and have many uses. Some such uses include aerospace applications, including for example such use in space vehicles as well as multistage rocket or missile configurations.

By way of non-limiting example, U.S. Pat. No. 10,989,243 discloses an explosive bolt for securing a brace in tension. The bolt includes a bar, a pair of explosives, a pair of detonators and a pair of anchors. The bar has opposing longitudinal ends and an outer thickness. Opposing bores extend inwardly from the longitudinal ends to corresponding depth ends. First and second notches reduce the thickness proximate to the corresponding depth ends. A center rod separates the notches from each other. Each explosive correspondingly inserts into a corresponding bore to a corresponding depth end. Each detonator correspondingly inserts into the corresponding bore. Each anchor secures the bar to the brace.

Also by way of non-limiting example, RU2705859 relates to space engineering, particularly, to separation bolts. Separation bolt for connection and subsequent fast disconnection of structure elements as per instruction includes power casing, charge and electric detonator.

Also by way of non-limiting example, U.S. Pat. No. 5,402,728 relates to a releasable attaching apparatus for attaching a portion of a first object to a portion of a second object. The attaching apparatus has an attaching member with walls defining a cavity therein. A rapidly expanding material is placed within the cavity such that when the material is caused to expand, the attaching member will break at a failure zone located adjacent to the cavity. The rapidly expanding material is a composition that undergoes a phase change from a solid to a liquid, wherein the volume of the liquid is larger than the volume of the solid. In operation, an initiator triggers the phase change which causes a pressure build-up in the cavity, thereby loading the attaching member and causing it to break at the failure zone. Accordingly, the first and second objects are freed from one another.

Also by way of non-limiting example, U.S. Pat. No. 4,316,412 discloses a low voltage, electrically actuated, nonprimary explosive detonator wherein said detonation is achieved by means of an explosive train in which a deflagration-to-detonation transition is made to occur. The explosive train is confined within a cylindrical body and positioned adjacent to low voltage ignition means have electrical leads extending outwardly from the cylindrical confining body. Application of a low voltage current to the electrical leads ignites a self-sustained deflagration in a donor portion of the explosive train which then is made to undergo a transition to detonation further down the train.

Also by way of non-limiting example, U.S. Pat. No. 3,792,662 discloses a system for the removal of an attachment from one end of a detonating device prior to the detonation of the main charge.

Also by way of non-limiting example, U.S. Pat. No. 3,530,759 discloses a severable element for use as a quick-disconnect connecting means and for other uses, comprising: a body; a chamber extending from an outer end of the body; a quantity of material in the inner end of the chamber which is substantially incompressible and is capable of being spread under pressure without disintegrating; an annular groove in the body defining a circumferential severing area of reduced cross-section; the inner end of said material being proximate said severing area; and means for applying pressure to said material to deform it and sever said element including a plunger having its inner end adjacent said material.

Also by way of non-limiting example, U.S. Pat. No. 3,196,746 discloses a releasable fastener which can be instantaneously severed at a predetermined location and which is characterized by substantially shrapnel-free and nonleaking operation, comprising: (a) an elongated housing adapted to engage with associated elements, said elongated housing having a central longitudinal bore closed at one end and containing in sequence from said end (b) a base charge of a high velocity detonating explosive, (c) a priming charge in propagating relationship to the base charge, (d) a rigid compression plunger contiguous to the priming charge, said plunger being slidably mounted in and peripherally engaged by the bore, (e) a plug of a pressure-extrudable material contiguous to said plunger and peripherally engaged by the bore, (f) rigid closure means contiguous to said plug and closing said bore, said closure means, plug and compression plunger each having an aperture therethrough which is substantially coaxial with the bore of said housing, and a length of low-energy detonation-transmitting cord extending through the aperture in the closure means and plug and terminating in propagating relationship to the priming charge, said cord being peripherally engaged by the wall of said aperture in the closure means and comprising a continuous core of explosive encased in a ductile metal sheath, said plug being in tight peripheral engagement with the sheath.

### GENERAL DESCRIPTION

According to a first aspect of the presently disclosed subject matter there is provided an explosive bolt system, comprising
an explosive bolt, comprising a shank having a first longitudinal end, an opposed second longitudinal end and a longitudinal axis, the explosive bolt being configured for securing two elements together between said first longitudinal end and said second longitudinal end; the shank including an internal chamber accommodating a first layer of a high density first secondary explosive material, and further accommodating a second layer of a low density second secondary explosive material in arming communication with the first layer;
an initiator device positioned with respect to the explosive bolt such that the initiator device is in arming communication with the explosive bolt.

For example, the initiator device has a propagation axis, and comprises a booster secondary explosive element material operatively connected to an initiator secondary explosive material via a command chord.

For example, the initiator device is positioned with respect to the explosive bolt such that the initiator secondary explosive material is in arming communication with the explosive bolt.

Additionally or alternatively, for example, the initiator device is positioned with respect to the explosive bolt such that the initiator secondary explosive material is in arming communication with the internal chamber.

Additionally or alternatively, for example, the initiator device is positioned with respect to the explosive bolt such that the initiator secondary explosive material is in arming communication with the second layer.

Additionally or alternatively, for example, the first layer is longitudinally juxtaposed with the second layer along said longitudinal axis.

Additionally or alternatively, for example, said first layer has a first axial length along said longitudinal axis, wherein said second layer has a second axial length along said longitudinal axis, and wherein said first axial length is shorter than said second axial length.

Additionally or alternatively, for example, the first layer is accommodated in a first chamber portion of the internal chamber and comprises a first quantity of said high density first secondary explosive material, and wherein the second layer is accommodated in a second chamber portion of the internal chamber and comprises a second quantity of said low density second secondary explosive material. For example, said first quantity is about the same as said second quantity; for example, the first quantity is within ±5% of the second quantity by weight.

Additionally or alternatively, for example, said first secondary explosive material comprises a first density, and wherein said second secondary explosive material comprises a second density, wherein said first density is about 1.6 g/cm³±0.05 g/cm³, and wherein said second density is about 1.4 g/cm³±0.05 g/cm³.

Additionally or alternatively, for example, each one of said first secondary explosive material and said second secondary explosive material includes any one of nitroaromatics and nitramines.

Additionally or alternatively, for example, each one of said first secondary explosive material and said second secondary explosive material complies at least with the US Department of Defense Design Criteria Standard, Safety Criteria for Fuze Design, designated MIL-STD-131.

Additionally or alternatively, for example, said first secondary explosive material and said second secondary explosive material are the same secondary explosive material.

Alternatively, for example, said first secondary explosive material and said second secondary explosive material are different secondary explosive materials with respect to one another.

Additionally or alternatively, for example, each one of said explosive bolt and said initiator device is devoid of primary explosive materials.

Additionally or alternatively, for example, said longitudinal axis and said propagation axis are orthogonal to one another.

Additionally or alternatively, for example, said second layer is in abutting contact with the first layer.

According to a second aspect of the presently disclosed subject matter, there is provided an explosive bolt comprising a shank having a first longitudinal and an opposed second longitudinal end and a longitudinal axis, the explosive bolt being configured for securing two elements together between said first longitudinal end and said second longitudinal end; the shank including an internal chamber accommodating a first layer of a high density first secondary explosive material, and further accommodating a second layer of a low density second secondary explosive material in abutting contact with the first layer.

For example, said first layer has a first axial length along said longitudinal axis, wherein said second layer has a second axial length along said longitudinal axis, and wherein said first axial length is shorter than said second axial length.

Additionally or alternatively, for example, the first layer is accommodated in a first chamber portion of the internal chamber and comprises a first quantity of said high density first secondary explosive material, and wherein the second layer is accommodated in a second chamber portion of the internal chamber and comprises a second quantity of said low density second secondary explosive material. For example, said first quantity is about the same as said second quantity; for example, the first quantity is within ±5% of the second quantity by weight.

Additionally or alternatively, for example, said first secondary explosive material comprises a first density, and wherein said second secondary explosive material comprises a second density, wherein said first density is about 1.6 g/cm³±0.05 g/cm³, and wherein said second density is about 1.4 g/cm³±0.05 g/cm³.

Additionally or alternatively, for example, each one of said first secondary explosive material and said second secondary explosive material includes any one of nitroaromatics and nitramines.

Additionally or alternatively, for example, each one of said first secondary explosive material and said second secondary explosive material complies at least with the US Department of Defense Design Criteria Standard, Safety Criteria for Fuze Design, designated MIL-STD-131.

Additionally or alternatively, for example, said first secondary explosive material and said second secondary explosive material are the same secondary explosive material.

Alternatively, for example, said first secondary explosive material and said second secondary explosive material are different secondary explosive materials with respect to one another.

Additionally or alternatively, for example, said explosive bolt is devoid of primary explosive materials.

Additionally or alternatively, for example, said second layer is in abutting contact with the first layer.

Additionally or alternatively, for example, said explosive bolt is configured for being actuated via an initiator device positioned with respect to the explosive bolt such that the initiator device is in arming communication with the explosive bolt.

According to a third aspect of the presently disclosed subject matter, there is provided a connection system for selectively engaging two elements to one another, comprising:
an explosive bolt system as defined herein regarding the first aspect of the presently disclosed subject matter, wherein one longitudinal end of the explosive bolt is coupled to one of said elements, and another longitudinal end of the bolt is coupled to the other one of said elements;
a detonator and safe and arm device, operatively coupled to the explosive bolt system.

According to a fourth aspect of the presently disclosed subject matter, there is provided a method for selectively engaging two elements to one another, comprising:
(a) providing an explosive bolt system as defined herein regarding the first aspect of the presently disclosed subject matter;
(b) coupling one longitudinal end of the explosive bolt to one of said elements, and coupling another longitudinal end of the bolt to the other one of said elements;
(c) operatively coupling a detonator and safe and arm device to the explosive bolt system.

According to a fifth aspect of the presently disclosed subject matter, there is provided a method for producing an explosive bolt comprising
providing a shank having a first longitudinal end, an opposed second longitudinal end and a longitudinal axis, the shank including an internal chamber
inserting a first quantity of first secondary explosive material in the internal chamber and applying a first compression pressure thereto to form a first layer of a high density said first secondary explosive material;
inserting a second quantity of second secondary explosive material in the internal chamber over the said first layer and applying a second compression pressure thereto to form a second layer of a low density said second secondary explosive material;
wherein said first compression pressure is greater than said second compression pressure.

For example, said first material and said second materials are each provided in powder form.

Additionally or alternatively, for example, said first quantity is about the same as said second quantity; for example, the first quantity is within +5% of the second quantity by weight.

Additionally or alternatively, for example, said first compression pressure compresses the first secondary explosive material to a first density, and wherein said second compression pressure compresses said second secondary explosive material to a second density, wherein said first density is about 1.6 g/cm³±0.05 g/cm³, and wherein said second density is about 1.4 g/cm³±0.05 g/cm³.

Additionally or alternatively, for example, each one of said first secondary explosive material and said second secondary explosive material includes any one of nitroaromatics and nitramines.

Additionally or alternatively, for example, each one of said first secondary explosive material and said second secondary explosive material complies at least with the US Department of Defense Design Criteria Standard, Safety Criteria for Fuze Design, designated MIL-STD-131.

Additionally or alternatively, for example, said first secondary explosive material and said second secondary explosive material are the same secondary explosive material. Alternatively, for example, said first secondary explosive material and said second secondary explosive material are different secondary explosive materials with respect to one another.

A feature of at least one example of the present disclosed subject matter is that an explosive bolt system is provided having high safety level.

Another feature of at least one example of the present disclosed subject matter is that an explosive bolt system is provided devoid of any primary explosive material.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a cross-section side view of an explosive bolt system according to a first example of the presently disclosed subject matter.

FIG. 2 is a cross-section side view of part of the example of FIG. 1.

FIG. 3 is a cross-section side view of the example of FIG. 1 in engaged relationship with two elements.

FIG. 4 is a cross-section side view of the example of FIG. 1 schematically illustrating a contiguous explosive train between the respective detonator and the respective explosive bolt.

### DETAILED DESCRIPTION

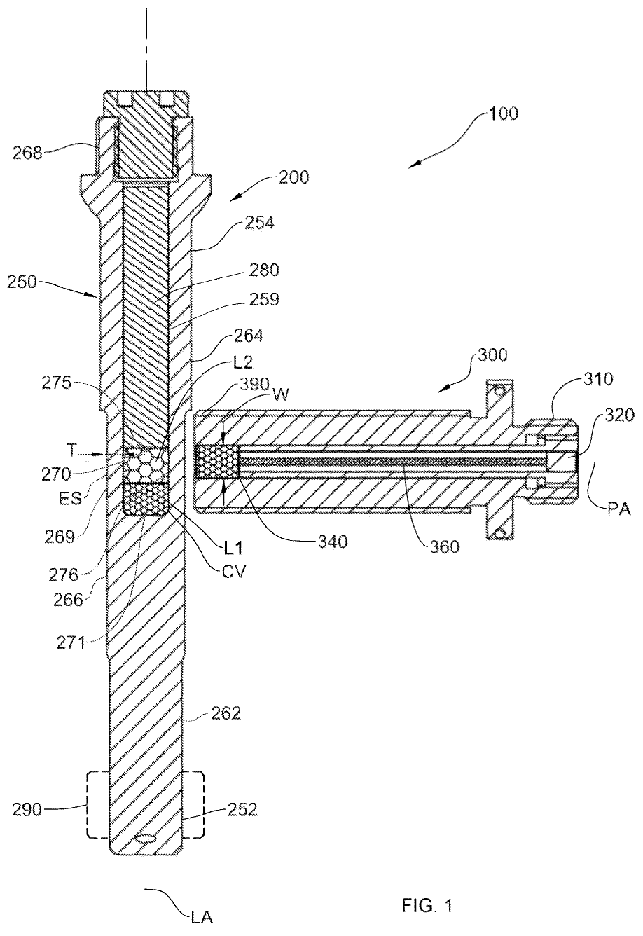

Referring to FIG. 1, an explosive bolt system according to a first example of the presently disclosed subject matter, generally designated 100 comprises an explosive bolt 200 and an initiator device 300.

The explosive bolt 200 (also interchangeably referred to herein as any one of “bolt”, “connection bolt” or “explosive connection bolt”) comprises a shank 250 and a head 268. The shank 250 has a longitudinal axis LA, a first longitudinal end 252 and an opposed second longitudinal end 254.

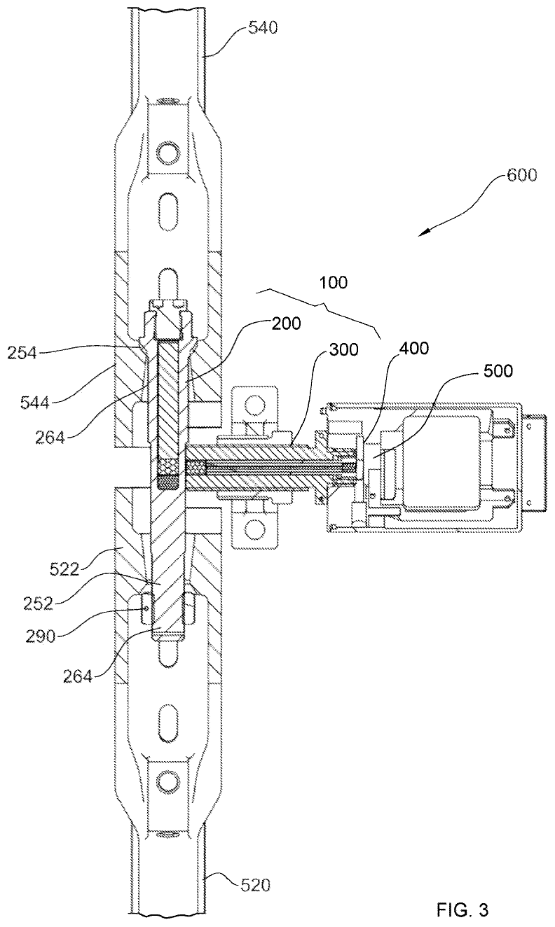

Referring also to FIG. 3, the explosive bolt 200 is configured for securing two elements 520, 540 together between the first longitudinal end 252 and the second longitudinal end 254. For example, the two elements 520, 540 can each be a respective end fitting at the respective one of two ends of the respective strap of a Marman clamp that circumferentially holds together two components, for example two stages of a multistage rocket.

In at least this example, and referring again to FIG. 1, the shank 250 includes a threaded portion 262 at the first longitudinal end 242, a grip portion 264 at the second longitudinal end 242, and a failure zone portion 266 between the grip portion 264 and the threaded portion 262.

The head 268 is juxtaposed with the grip portion 264, and is configured for being grippable by a suitable tool, for example a spanner, for enabling the explosive bolt 200 to the turned about the longitudinal axis LA.

The threaded portion 262 comprises an external thread typically complementary to an internal thread of a nut 290.

Referring again to FIG. 3, the grip portion 264 together with the head 268 are generally configured for cooperating with a respective portion 544 of one element 540, while the threaded portion 262 together with nut 290 are generally configured for cooperating with a respective portion 522 of the other element 520, thereby enabling the two elements 520, 540 to be secured together via the explosive bolt 200.

In at least this example, the grip portion 264, the failure zone portion 266 and the threaded portion 262 are integrally formed with one another to form an integral shank 250. Furthermore in at least this example, the head 268, the grip portion 264, the failure zone portion 266 and the threaded portion 262 are integrally formed with one another.

The shank 250 is configured with an internal chamber 270, which at least in this example is located partially or wholly at a corresponding chamber portion 269 of the failure zone portion 266. The chamber 270 thus comprises a lower chamber base 271, upper chamber end 275 and inner peripheral surface 276, which together define the chamber volume CV of internal chamber 270. The peripheral surface 276 together with the external surface ES of the shank 250 at the failure zone portion 266, in particular at the chamber portion 269, define the wall thickness T of a chamber portion 269 of the failure zone portion 266 corresponding to the chamber 270.

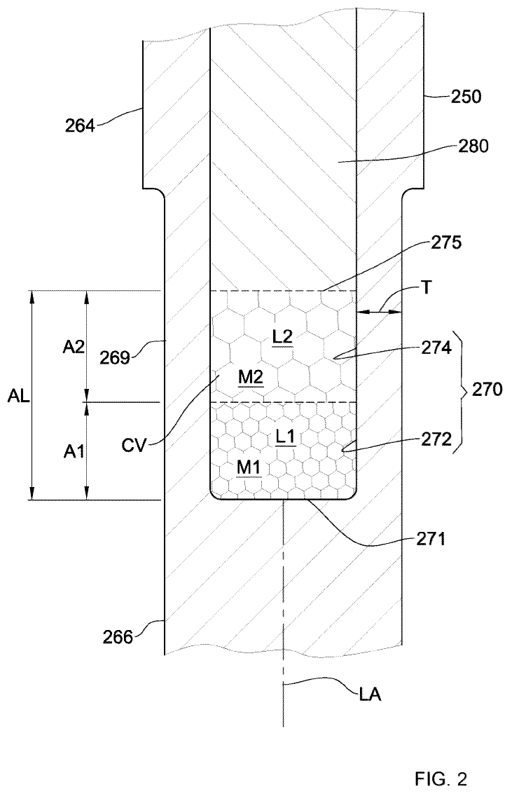

Referring also to FIG. 2, the chamber 270 accommodates a first layer L1 of a first high density secondary explosive material M1, and further accommodates a second layer L2 of a second low density secondary explosive material M2. The first layer L1 is accommodated in a first chamber portion 272 of the chamber 270, and the second layer L2 is accommodated in a second chamber portion 274 of the chamber 270.

The first layer L1 is in arming communication with the second layer L2 in the chamber 270.

The term “arming communication” as used herein refers to the type of communication or contact between first high density secondary explosive material M1 accommodated in first layer L1, and the second low density secondary explosive material M2 accommodated in second layer L2, that is such as to establish a contiguous explosive train between second layer L2 and the first layer L1. For example, such “arming communication” between the second layer L2 and the first layer L1 allows a detonation wave to travel from the second secondary material M2 accommodated in the second layer L2 to the first high density secondary explosive material M1 accommodated in first layer L1, thereby causing first high density secondary explosive material M1 accommodated in first layer L1 to detonate.

In at least this example, the first layer L1 is in abutting contact with the second layer L2 in the chamber 270. In at least this example, the first layer L1 is longitudinally juxtaposed with the second layer L2 along the longitudinal axis LA.

The first layer L1 has a first axial length A1 along the longitudinal axis LA, and the second layer L2 has a second axial length A2 along the longitudinal axis LA.

In at least this example, the summation of the first axial length A1 and the second axial length A2 nominally corresponds to the axial length AL of the chamber 270. However, in alternative variations of this example, the summation of the first axial length A1 and the second axial length A2 is less than the axial length AL of the chamber 270, providing a corresponding headspace, which can contain air for example.

In at least this example, the first axial length A1 is shorter than the second axial length A2. Such an arrangement can, in at least some applications of this example, reduce the need for high tolerance in the alignment between the explosive bolt 200 and the initiator device 300, in particular, in the alignment between the initiator device 300 and the second layer L2.

For example, a ratio between the second axial length A2 and the first axial length A1 can be in the range of between about 1.05 and about 1.20.

In at least one example, first axial length A1 can be about 4.9 mm, and the second axial length A2 can be about 5.4 mm.

In other alternative variation of these examples, the first axial length A1 can be the same length or greater than the second axial length A2.

In the above or other examples, the internal chamber 270 can have an internal diameter of about 7 mm.

In at least this example the chamber 270 has uniform transverse cross-section along the full axial length AL thereof. Furthermore, the transverse cross-section is axisymmetric, in particular circular, providing a uniform wall thickness T for the chamber portion 269.

In at least some examples, for example in the illustrated example, such a thickness T can be about 2.5 mm, for example.

Referring again to FIG. 1, the chamber 270 constitutes an end part of a longitudinal bore 259 extending longitudinally from an outer longitudinal end of the head 268 up to lower chamber base 271. A plug member 280 is provided, configured for sealingly closing part of the bore 259, extending longitudinally from the outer longitudinal end of the head 268 (or close thereto) up to upper chamber end 275, thereby creating the chamber 270.

In alternative variations of this example, the transverse cross-sections of the chamber 270 can be non-circular, and/or, the chamber 270 has a non-uniform transverse cross-section along the full axial length AL thereof.

In at least one such example, the chamber 270, or part thereof can have a frusto-conical shape in which the transverse cross-sectional area decreases in a direction from the second longitudinal end 254 to the first longitudinal end 252.

In at least one other such example, the chamber 270 has a stepped longitudinal configuration. In such an example, the first chamber portion 272 corresponding to, and coextending along the first axial length A1 of, the first layer L1, and the second chamber portion 274 corresponding to, and coextending along the second axial length A2 of, the second layer L2, have different transverse widths and/or cross-sectional areas. In such an example, for example, the diameter of the first chamber portion 272 can be greater than, or less than, the diameter of the second chamber portion 274. For example, an annular sleeve can be provided in the bore 259, and having an internal lumen corresponding to the plug member 280, to thereby provide the respective first chamber portion 272 and the respective second chamber portion 274.

In at least one other such example, the chamber 270 has a transverse offset configuration, wherein the first chamber portion 272 (corresponding to, and coextending along the first axial length A1 of, the first layer L1), is transversely offset with respect to the second chamber portion 274 (corresponding to, and coextending along the second axial length A2 of, the second layer L2). In such an example, for example, the diameter of the first chamber portion 272 can be greater than, equal to, or less than, the diameter of the second chamber portion 274. However, the central longitudinal axis of the first chamber portion 272 is not coaxial with the central longitudinal axis of the second chamber portion 274 but is instead transversely spaced with respect thereto. Furthermore, the central longitudinal axis of the first chamber portion 272 and/or the central longitudinal axis of the second chamber portion 274 is/are not coaxial with the longitudinal axis LA. In such examples, the wall thickness T of the respective chamber portion 269, in particular of the respective first chamber portion 272 and/or of the second chamber portion 274 is correspondingly not uniform circumferentially with respect to the longitudinal axis LA. In at least one such example, the wall thickness T can have a minimum magnitude at a circumferential part of the chamber portion 269 that is intended to be facing the initiator device 300 during operation of the explosive bolt system 100.

In at least one other such example, the chamber 270 has a non-axisymmetric or non-circular transverse cross-section, for example along part or all of the first axial length A1 of the first chamber portion 272, and/or along part or all of the second axial length A2 of the second chamber portion 274.

In at least the illustrated example, and referring again to FIG. 1, the first layer L1 and the first chamber portion 272 are closer than the second layer L2 and the second chamber portion 274 with respect to the first longitudinal end 252. Thus in at least this example, the second layer L2 and the second chamber portion 274 are closer than the first layer L1 and the first chamber portion 272 with respect to the second longitudinal end 254. However, in at least some alternative variations of this example, first layer L1 and the first chamber portion 272 are closer than the second layer L2 and the second chamber portion 274 with respect to the second longitudinal end 254, and, the second layer L2 and the second chamber portion 274 are closer than the first layer L1 and the first chamber portion 272 with respect to the first longitudinal end 252.

The shank 250, head 268 and plug member 280 can be made from any suitable material capable of supporting the respective mechanical loads while the explosive bolt 200 is securing the two elements 520, 540. In at least this example, the shank 250, head 268 and plug member 280 are made from stainless steel, for example.

According to an aspect of the presently disclosed subject matter, the explosive bolt 200 comprises only secondary explosive material, and is devoid of any primary explosive material.

In the art, explosive materials are generally classified as being primary explosive materials or secondary explosive materials based on the sensitivity of the explosive materials to initiation or detonation. In general, primary explosive materials are susceptible to being detonated by the application of sufficient heat, which can originate from an ignition source, application of friction or other mechanical force, for example. On the other hand, in general secondary explosive materials are safer to handle and detonate only under specific conditions including the use of a detonator or an initiator device, for example initiator device 300.

In at least this example, the first secondary explosive material M1 and the first secondary explosive material M2 are the same secondary explosive material. However, in alternative variations of this example, the first secondary explosive material M1 and the first secondary explosive material M2 are different from one another, i.e., are different secondary explosive materials one from the other.

For example, the first secondary explosive material M1 and/or the first secondary explosive material M2 can include nitroaromatics, for example TNT.

For example, the first secondary explosive material M1 and/or the first secondary explosive material M2 can include nitramines, for example RDX or CH-6.

In these or other examples, and according to an aspect of the presently disclosed subject matter, the first secondary explosive material M1 and/or the first secondary explosive material M2 comply at least with the US Department of Defense Design Criteria Standard, Safety Criteria for Fuze Design, MIL-STD-131, for example MIL-STD-131F, for example any one of the approved Explosives as listed in Table I.

TABLE I
Approved Explosives

| Explosive | Specification |
|---|---|
| Comp A3 | MIL-DTL-440 |
| Comp A4 | MIL-DTL-440 |
| Comp A5 | MIL-DTL-14970 |
| Comp CH6 | MIL-C-21723 |
| DIPAM | WS-4660 |
| HNS Type 1 or Type 2 Gr A | WS-5003 |
| HNS-IV | MIL-E-82903 |
| LX-14 | MIL-H-48358 |
| PBX 9407 | MIL-R-63419 |
| PBXN-5 | MIL-E-81111 |
| PBXN-6 | WS-12604 |
| PBXN-7 | MIL-DTL-82874 |
| PBXN-9 | MIL-DTL-82875 |
| PBXN-11 | MIL-DTL-32064 |
| PBXN-301 | MIL-E-82740 |
| PBXN-12 | MIL-DTL-3228 |

The first layer L1 is accommodated in a first chamber portion 272 of the chamber 270, and comprises a first quantity of high density first secondary explosive material M1, i.e., in this first quantity of the first secondary explosive material M1, the first secondary explosive material M1 is provided at a first density DN1. The second layer L2 is accommodated in a second chamber portion 274 of the chamber 270, and comprises a second quantity of high density second secondary explosive material M2, i.e., in this second quantity of the second secondary explosive material M2, the second secondary explosive material M2 is provided at a second density DN2. The second quantity of the second secondary explosive material M2 at second density DN2 is sufficient to be detonated by the initiator device 300 during operation of the system 100, and sufficient for detonating the first secondary explosive material M1 accommodated in the first layer L1. The first quantity of high density first secondary explosive material M1 at first density DN1 is sufficient to ensure, when detonated, that the explosive bolt 200 breaks and separates into two sections at the failure zone portion 266.

For example, the first quantity of the first secondary explosive material M1 can be the same magnitude as the second quantity of the second secondary explosive material M2; for example, the first quantity of the first secondary explosive material M1 is within ±5% of the second quantity of the second secondary explosive material M2 by weight. For example, the first quantity of the first secondary explosive material M1 and the second secondary explosive material M2 can each be about 300 mg. In alternative variations of this example, the first quantity of the first secondary explosive material M1 can be greater or less than the second quantity of the second secondary explosive material M2.

According to an aspect of the presently disclosed subject matter, the first density DN1 is different from the second density DN2. In the illustrated example, the first density DN1 is greater than the second density DN2; furthermore, the first density DN1 is considered to be a “high density” as compared with second density DN2, which is considered low density as compared with the first density DN1.

For example, the first density DN1 can be a density of 1.6 g/cm³±0.05 g/cm³, while the second density DN2 can be a density of 1.4 g/cm³±0.05 g/cm³.

In at least this example, the first quantity of first secondary material M1, for example in powder form, is inserted into the first chamber portion 272 via the bore 259, when the plug member 280 is not present. A suitable first compressing tool can then be inserted into the bore 259 and into abutting contact with the first secondary material M1 in the first chamber portion 272 via the bore 259. The first secondary material M1 can then be compressed via the compressing tool until the first density DN1 is achieved for the first secondary material M1, thereby providing the first layer L1. For example, such a compressing tool can comprise a bar having diameter slightly smaller than the inside diameter of the bore 259, and of sufficient axial length such that when fully inserted in the bore an end of the tool projects outside of the open end of the head 268. A suitable mechanical stop can be provided for the compression tool and located at a calibrated location such as to limit longitudinal penetration into the bore 259 and chamber 270, and thus prevent excessive compression of the first secondary material M1. The second quantity of second secondary material M2, for example in powder form, can then be inserted into the second chamber portion 274, and added directly over the existing first layer L1, via the bore 259, absent plug member 280, for example via a suitable second compressing tool that similarly ensures the require second density DN2 is achieved for the second secondary material M2. Thereafter, the plug member 280 can be sealingly inserted into the bore 259, isolating the chamber 270 and its contents from the outside of the explosive bolt 200.

Thus, according to an example of a method for producing such an explosive bolt, essentially the first quantity of first secondary explosive material M1 is inserted into the internal chamber and a first compression pressure is applied thereto via the first compressing tool to form the first layer L1 of the high density said first secondary explosive material. Then, the second quantity of second secondary explosive material M2 is inserted into the internal chamber over the said first layer L1 and a second compression pressure is applied thereto via the second compressing tool to form the second layer L2 of low density said second secondary explosive material. In at least this example, the first compression pressure is greater than the second compression pressure. The first compression pressure is thus sufficient to compress the first secondary explosive material M1 to the first density DN1, and the second compression pressure is thus sufficient to compress the second secondary explosive material M2 to the second density DN2.

Referring again to FIG. 1, the initiator device 300 is configured for selectively initiating detonation of the explosive bolt 200, as will become clearer herein.

The initiator device 300 has a propagation axis PA, and comprises a booster secondary explosive element material 320 operatively connected to an initiator secondary explosive material 340 via a command chord 360.

The booster secondary explosive element material 320 is provided at one longitudinal end 310 of the initiator device 300, and the booster secondary explosive element material 320 is operatively connected to the safe and arm device 400 in operation of the system 100.

The initiator secondary explosive material 340 is provided at the opposed longitudinal end 390 of the initiator device 300.

The booster secondary explosive element material 320, the initiator secondary explosive material 340 and the command chord 360 are each secondary explosive materials. The booster secondary explosive element material 320, the initiator secondary explosive material 340 and the command chord 360 can be the same secondary explosive material with respect to one another, or, the booster secondary explosive element material 320, the initiator secondary explosive material 340 and the command chord 360 can be different secondary explosive materials with respect to one another. For example, the booster secondary explosive element material 320 and/or the initiator secondary explosive material 340 and/or the command chord 360 can include nitroaromatics, for example TNT, or can include nitramines, for example RDX or CH-6. In these or other examples, and according to an aspect of the presently disclosed subject matter, the booster secondary explosive element material 320 and/or the initiator secondary explosive material 340 and/or the command chord 360 comply at least with the US Department of Defense Design Criteria Standard, Safety Criteria for Fuze Design, MIL-STD-131, for example MIL-STD-131F, for example any one of the approved Explosives as listed in Table I above.

The booster secondary explosive element material 320 and/or the initiator secondary explosive material 340 and/or the command chord 360 can be the same secondary explosive materials as, or can be different from, the first secondary explosive material M1 and/or the first secondary explosive material M2.

According to an aspect of the presently disclosed subject matter, the initiator device 300 comprises only secondary explosive material, and is devoid of any primary explosive material.

The initiator device 300 is positioned, particularly in alignment, with respect to the explosive bolt 200 such that the initiator device 300 is in arming communication with the explosive bolt 200. In particular, the initiator device 300 is positioned with respect to the explosive bolt 200 such that the initiator secondary explosive material 340 is in arming communication with the explosive bolt 200. More in particular, the initiator device 300 is positioned with respect to the explosive bolt 200 such that the initiator secondary explosive material 340 is in arming communication with the chamber 270. More in particular, the initiator device 300 is positioned with respect to the explosive bolt 200 such that the initiator secondary explosive material 340 is in arming communication with the second layer L2.

The term “arming communication” as also used herein refers to the type of communication or contact ultimately between initiator secondary explosive material 340 and the second secondary material M2 accommodated in the second layer L2 that is such as to establish a contiguous explosive train between the initiator device 300 and the explosive bolt 200. For example, such “arming communication” between the initiator device 300 and the explosive bolt 200 allows a detonation wave to travel from the initiator device 300 to the explosive bolt 200, in particular from the initiator secondary explosive material 340 to the second secondary material M2 accommodated in the second layer L2, thereby causing the second secondary material M2 accommodated in the second layer L2 to detonate.

In at least this example, the initiator device 300 is positioned with respect to the explosive bolt 200 such that the initiator secondary explosive material 340 is facing, and in close proximity to or in abutment with, the explosive bolt 200.

In particular, the initiator device 300 is positioned with respect to the explosive bolt 200 such that initiator secondary explosive material 340 is facing, and in close proximity to or in abutment with, the failure zone portion 266.

More in particular, the initiator device 300 is positioned with respect to the explosive bolt 200 such that initiator secondary explosive material 340 is facing, and in close proximity to or in abutment with, the chamber portion 269.

More in particular, the initiator device 300 is positioned with respect to the explosive bolt 200 such that initiator secondary explosive material 340 is facing, and in close proximity to or in abutment with, a part of the chamber portion 269 corresponding to the second layer L2.

In at least this example, the width W of the initiator secondary explosive material 340 in a direction parallel to the longitudinal axis LA of the explosive bolt 200 is about the same magnitude as the second axial length A2.

In at least this example, the propagation axis PA is orthogonal to the longitudinal axis LA. Furthermore in at least this example, the propagation axis PA intersects the longitudinal axis LA.

However, in at least some alternative variations of this example, the propagation axis PA can be at any suitable non-parallel angular orientation with respect to the longitudinal axis LA, for example any one of 30°, 45°, 60°, 80°. Additionally or alternatively, in such examples the propagation axis PA does not intersect the longitudinal axis LA and is instead the propagation axis PA is offset with respect to the longitudinal axis LA. However, in such cases, the orientation and relative spatial disposition of the propagation axis PA with respect to the longitudinal axis LA is still such that the initiator secondary explosive material 340 is ion arming communication with the second layer L2, for example facing, and in close proximity to or in abutment with the external wall of the first chamber portion 272 corresponding to the second layer L2.

Referring also to FIG. 3, when the system 100 is used as part of a connection system 600 for selectively engaging two elements to one another, for example, the initiator device 300 is operatively coupled to a detonator 500 via a safe and arm device 400. In at least this example, the detonator 500 and the safe and arm device 400 are together configured as an integral and self-contained component, and provides isolation of the relatively insensitive secondary explosives of the initiator device 300 from external stimuli that could otherwise transfer enough energy to initiate the detonator 500. Such isolation can be provided by a mechanical barrier between the detonator 500 and the secondary explosives of the initiator device 300 when the safe and arm device 400 is in the safe mode, and the mechanical barrier is an integral part of the safe and arm device 400. The mechanical barrier operates to block transmission of any explosive shock from the detonator to the initiator device 300 that may occur in response to any such stimuli. In the armed mode, the mechanical barrier is removed, and is replaced with a transfer lead that allows energy from the detonator 500 to flow to the secondary explosives of initiator device 300 and detonate the same, typically in response to the detonator 500 receiving a command signal from a controller, for example when it is desired to separate the two elements 520, 540.

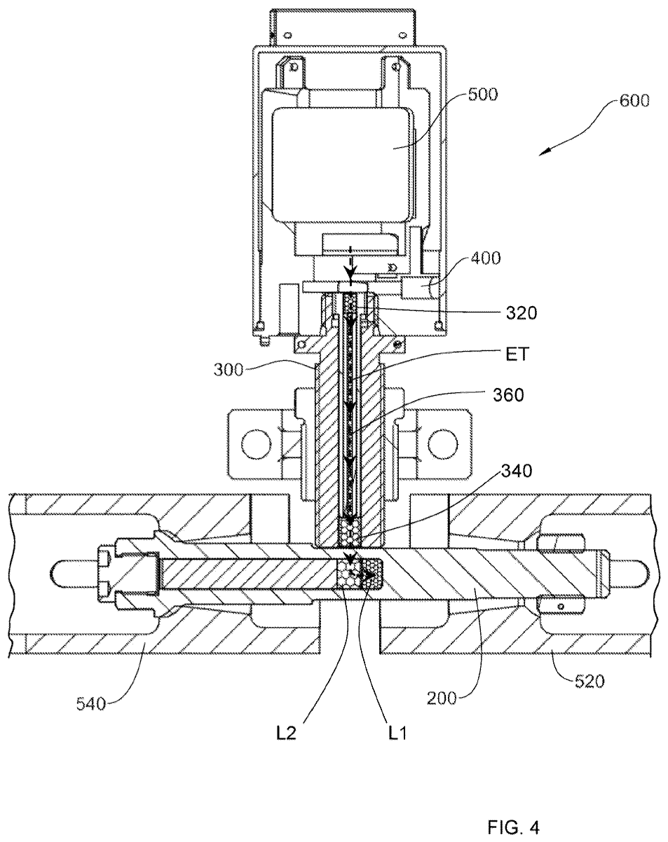

In operation of the system 100 in such a connection system 600, and referring to FIG. 4, a command signal is transmitted to the detonator 500 and the safe and arm device 400. The safe and arm device 400 switches to arm mode from safe mode, by removing the mechanical barrier between the detonator 500 and the initiator device 300. The detonator 500 initiates and establishes a contiguous explosive train ET between the detonator 500 and the explosive bolt 200. Responsive to receiving such a command signal, the detonator 500 generates a detonation wave that travels from the detonator 500 through the safe and arm device 400 and to the initiator device 300, detonating first the booster secondary explosive element material 320, which in turn detonates the initiator secondary explosive material 340 via propagation of the detonation wave through the command chord 360. Detonation of the initiator secondary explosive material 340 causes the detonation wave in the contiguous explosive train ET to detonate the second secondary material M2 accommodated in the second layer L2, which in turn causes the first secondary material M1 accommodated in the first layer L1 to detonate. The detonation of the first secondary material M1 accommodated in the first layer L1 in the final portion of the contiguous explosive train ET results in the rupture or break of the explosive bolt 200, in particular at the failure zone portion 266, in the vicinity of the chamber portion 269, which splits and separates the explosive bolt 200 into two major portions, thereby disengaging the elements 520, 540 from one another.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. An explosive bolt system, comprising:
an explosive bolt, comprising a shank having a first longitudinal end, an opposed second longitudinal end and a longitudinal axis, the explosive bolt being configured for securing two elements together between said first longitudinal end and said second longitudinal end; the shank including an internal chamber accommodating a first layer of a high density first secondary explosive material, and further accommodating a second layer of a low density second secondary explosive material in arming communication with the first layer; and
an initiator device positioned with respect to the explosive bolt such that the initiator device is in arming communication with the explosive bolt.

2. The explosive bolt system according to claim 1, wherein the initiator device has a propagation axis, and comprises a booster secondary explosive element material operatively connected to an initiator secondary explosive material via a command chord.

3. The explosive bolt system according to claim 2, wherein the initiator device is positioned with respect to the explosive bolt such that the initiator secondary explosive material is in arming communication with the explosive bolt.

4. The explosive bolt system according to claim 2, wherein the initiator device is positioned with respect to the explosive bolt such that the initiator secondary explosive material is in arming communication with the internal chamber.

5. The explosive bolt system according to claim 2, wherein the initiator device is positioned with respect to the explosive bolt such that the initiator secondary explosive material is in arming communication with the second layer.

6. The explosive bolt system according to claim 1, wherein the first layer is longitudinally juxtaposed with the second layer along said longitudinal axis.

7. The explosive bolt system according to claim 1, wherein said first layer has a first axial length along said longitudinal axis, wherein said second layer has a second axial length along said longitudinal axis, and wherein said first axial length is shorter than said second axial length.

8. The explosive bolt system according to claim 1, including one of the following:
wherein the first layer is accommodated in a first chamber portion of the internal chamber and comprises a first quantity of said high density first secondary explosive material, and wherein the second layer is accommodated in a second chamber portion of the internal chamber and comprises a second quantity of said low density second secondary explosive material; or
wherein the first layer is accommodated in a first chamber portion of the internal chamber and comprises a first quantity of said high density first secondary explosive material, and wherein the second layer is accommodated in a second chamber portion of the internal chamber and comprises a second quantity of said low density second secondary explosive material, and, wherein said first quantity is about the same as said second quantity.

9. (canceled)

10. The explosive bolt system according to claim 1, wherein said first secondary explosive material comprises a first density, and wherein said second secondary explosive material comprises a second density, wherein said first density is about 1.6 g/cm³±0.05 g/cm³, and wherein said second density is about 1.4 g/cm³±0.05 g/cm³.

11. The explosive bolt system according to claim 1, wherein each one of said first secondary explosive material and said second secondary explosive material includes any one of nitroaromatics and nitramines.

12. The explosive bolt system according to claim 1, wherein each one of said first secondary explosive material and said second secondary explosive material complies at least with the US Department of Defense Design Criteria Standard, Safety Criteria for Fuze Design, designated MIL-STD-131.

13. The explosive bolt system according to claim 1, ding one of the following:
wherein said first secondary explosive material and said second secondary explosive material are the same secondary explosive material; or
wherein said first secondary explosive material and said secondary explosive material are different secondary explosive materials with respect to one another.

14. (canceled)

15. The explosive bolt system according to claim 1, wherein each one of said explosive bolt and said initiator device is devoid of primary explosive materials.

16. The explosive bolt system according to claim 2, wherein said longitudinal axis and said propagation axis are orthogonal to one another.

17. The explosive bolt system according to claim 1, wherein said second layer is in abutting contact with the first layer.

18. An explosive bolt comprising a shank having a first longitudinal and an opposed second longitudinal end and a longitudinal axis, the explosive bolt being configured for securing two elements together between said first longitudinal end and said second longitudinal end; the shank including an internal chamber accommodating a first layer of a high density first secondary explosive material, and further accommodating a second layer of a low density second secondary explosive material in abutting contact with the first layer.

19. The explosive bolt according to claim 18, including at least one of the following:
wherein said first layer has a first axial length along said longitudinal axis, wherein said second layer has a second axial length along said longitudinal axis, and wherein said first axial length is shorter than said second axial length;
wherein the first layer is accommodated in a first chamber portion of the internal chamber and comprises a first quantity of said high density first secondary explosive material, and wherein the second layer is accommodated in a second chamber portion of the internal chamber and comprises a second quantity of said lower density second secondary explosive material, or, wherein the first layer is accommodated in a first chamber portion of the internal chamber and comprises a first quantity of said high density first secondary explosive material, and wherein the second layer is accommodated in a second chamber portion of the internal chamber and comprises a second quantity of said low density second secondary explosive material and wherein said first quantity is about the same as said second quantity;
wherein said first secondary explosive material comprises a first density, and wherein said second secondary explosive material comprises a second density, wherein said first density is about 1.6 g/cm³±0.05 g/cm³, and wherein said second density is about 1.4 g/cm³±0.05 g/cm³;
wherein each one of said first secondary explosive material and said second secondary explosive material includes any one of nitroaromatics and nitramines;
wherein each one of said first secondary explosive material and said second secondary explosive material complies at least with the US Department of Defense Design Criteria Standard, Safety Criteria for Fuze Design, designated MIL-STD-131;
wherein said first secondary explosive material and said second secondary explosive material are the same secondary explosive material, or, wherein said first secondary explosive material and said second secondary explosive material are different secondary explosive materials with respect to one another;
wherein said explosive bolt is devoid of primary explosive materials;
wherein said second layer is in abutting contact with the first layer; or
wherein said explosive bolt is configured for being actuated via an initiator device positioned with respect to the explosive bolt such that the initiator device is in arming communication with the explosive bolt.

20. (canceled)

21. (canceled)

22. (canceled)

23. (canceled)

24. (canceled)

25. (canceled)

26. (canceled)

27. (canceled)

28. (canceled)

29. (canceled)

30. A connection system for selectively engaging two elements to one another, the connection system comprising:
an explosive bolt system as defined in claim 1, wherein one longitudinal end of the explosive bolt is coupled to one of said elements, and another longitudinal end of the bolt is coupled to the other one of said elements;
a detonator and safe and arm device, operatively coupled to the explosive bolt system.

31. A method for selectively engaging two elements to one another, the method 2 comprising:
(a) providing an explosive bolt system as defined in claim 1;
(b) coupling one longitudinal end of the explosive bolt to one of said elements, and coupling another longitudinal end of the bolt to the other one of said elements;
(c) operatively coupling a detonator and safe and arm device to the explosive bolt system.

32. A method for producing an explosive bolt, the method comprising:
providing a shank having a first longitudinal end, an opposed second longitudinal end and a longitudinal axis, the shank including an internal chamber
inserting a first quantity of first secondary explosive material in the internal chamber and applying a first compression pressure thereto to form a first layer of a high density said first secondary explosive material; and
inserting a second quantity of second secondary explosive material in the internal chamber over the first layer and applying a second compression pressure thereto to form a second layer of a low density said second secondary explosive material;
wherein said first compression pressure is greater than said second compression pressure.

33. The method according to claim 32, including at least one of the following:
wherein said first material and said second materials are each provided in powder form;
wherein said first quantity is about the same as said second quantity;
wherein said first compression pressure compresses the first secondary explosive material to a first density, and wherein said second compression pressure compresses said second secondary explosive material to a second density, wherein said first density is about 1.6 g/cm³±0.05 g/cm³, and wherein said second density is about 1.4 g/cm³±0.05 g/cm³;
wherein each one of said first secondary explosive material and said second secondary explosive material includes any one of nitroaromatics and nitramines;
wherein each one of said first secondary explosive material and said second secondary explosive material complies at least with the US Department of Defense Design Criteria Standard, Safety Criteria for Fuze Design, designated MIL-STD-131; or
wherein said first secondary explosive material and said second secondary explosive material are the same secondary explosive material, or, wherein said first secondary explosive material and said second secondary explosive material are different secondary explosive materials with respect to one another.

34. (canceled)

35. (canceled)

36. (canceled)

37. (canceled)

38. (canceled)

39. (canceled)
